(19) United States
(12) Patent Application Publication
(10) Pub. No.: US 2008/0130504 A1
(43) Pub. Date: Jun. 5, 2008

(54) Integrated Quality of Service and Resource Management in a Network Edge Device

(75) Inventor: George Elmasry, Farmingdale, NJ (US)

Correspondence Address: Catalina & Associates;A Professional Corporation, 1319 Park Street, Suite 100, Robbinsville, NJ, 08691, US

(73) Assignee: D&S Consultants, Inc., Eatontown, NJ (US)

(21) Appl. No.: 11/949,906

(22) Filed: Dec. 4, 2007

Related U.S. Application Data
(60) Provisional application No. 60/872,723, filed on Dec. 4, 2006.

(51) Int. Cl. G06F 11/00; H04L 12/56; H04K 1/00

(52) U.S. Cl. 370/235; 370/389; 370/390; 370/241; 380/255; 370/230

(57) ABSTRACT

An apparatus for providing Quality of Service (QoS) and resource management in a network edge device of a core communication network is disclosed. The apparatus has scalable modular hardware/software architecture and adapted for receiving detachable functional units. Each functional unit may contain at least one module performing one or more pre-selected QoS and resource management functions in the network edge device.

### CROSS-REFERENCE TO RELATED APPLICATIONS

This application claims benefit of U.S. provisional patent application Ser. No. 60/872723, filed Dec. 4, 2006, which is herein incorporated by reference in its entirety.

### FIELD OF THE INVENTION

The present inventions generally relates to the field of communication networks and, in particular, to techniques for providing Quality of Service (QoS) and resource management functions in a network edge device of a communication network.

### BACKGROUND OF THE INVENTION

As complexity of computer networks increases, effectiveness of providing QoS and resource management solutions at network edges becomes more important. Herein, the term “network edge” broadly refers to routers, switches, routing switches, integrated access devices (IADs), and the like devices that facilitate an access point for one or more subnets (for example, Local Area Networks (LANs)), to core communication networks (for example, Wide Area Networks (WANs)).

Despite the considerable effort in the art devoted to increasing performance Quality of Service (QoS) and resource management functions in network edge devices of communication networks, further improvements would be desirable.

### SUMMARY OF THE INVENTION

Embodiments of the present invention are generally directed to an apparatus for providing QoS and resource management in a network edge device of a core network, such as a commercial or military communication network.

In one aspect of the invention, such an apparatus has a scalable modular structure. The apparatus is adapted for receiving functional units, and each functional unit may contain at least one module performing one or more pre-selected QoS and resource management functions.

Various other aspects and embodiments of the invention are described in further detail below.

The Summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIGS. 1A-1B are schematic diagram of portions of exemplary communication networks adapted for using the present invention.

FIG. 2 is a schematic perspective view of an integrated management apparatus of a network edge device in accordance with one embodiment of the present invention.

In the figures, like references indicate similar elements, except that suffixes may be added, when appropriate, to differentiate such elements. Images in the figures are simplified for clarity and are not drawn to scale.

The appended drawings illustrate exemplary embodiments of the invention and, as such, should not be considered as limiting the scope of the invention that may admit to other equally effective embodiments. It is contemplated that features or steps of one embodiment may beneficially be incorporated in other embodiments without further recitation.

### DETAILED DESCRIPTION

The terms “exemplary” and “illustrative” are used herein to mean “serving as an example, instance, or illustration.” Embodiments described as “exemplary” or “illustrative” are not necessarily to be construed as preferred or advantageous over other embodiments.

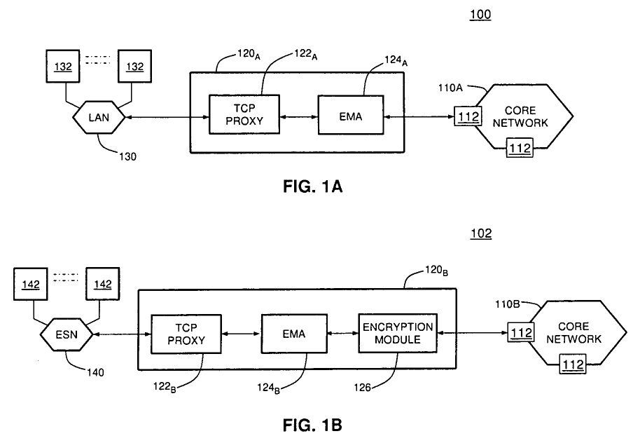

Referring to the figures, FIGS. 1A-1B depicts a high-level, schematic diagram of an enterprise communication network 100 and a secure communication network 102. In one embodiment, the communication network 102 is compliant with at least one data encryption protocol (for example, High Assurance Internet Protocol Encryption (HAIPE) or an IP Security (IPSec) protocol). Generally, the networks 100 and 102 are Internet Protocol (IP) based wireless, wired, or fiber-optic communication networks.

Illustratively, the networks 100 and 102 comprise an enterprise core network 110A and a secure core network 110B, each having a plurality of switches (or, alternatively, routers) 112 and network edges devices 120 (network edge devices 120A and 120B are shown). Illustratively, the network edge device 120A is an access point or, alternatively, gateway for client devices 132 of an enterprise LAN 130, and the network edge device 120B is such an access point or a gateway for client devices 142 of an encrypted subnet (ESN) 140 (e.g., military, government, or high-security commercial LAN).

The network edge 120A of the core network 110A includes a Transmission Control Protocol (TCP) proxy 122A and an integrated management apparatus (IMA) 124A. Correspondingly, the network edge 120B of the core network 110B includes the Transmission Control Protocol (TCP) module 122B, an edge management apparatus 124B, and an encryption module 126 that, in operation, performs HAIPE or IPSec protocol-based data encoding/decoding operations.

The TCP proxies 122 administer incoming and outgoing packetized data traffic between the network edge devices 120 and their respective subnets (e.g., LAN 130 and ESN 140) and, alternatively or additionally, between the network edge devices 120 themselves. At a TCP proxy, packet flow streams received from the respective client devices are terminated and reconstructed in transmission units, or segments, for delivery to a TCP proxy of another network edge device 120 of the core network 110. The TCP proxy 122 may be realized as a software module, a hardware device, or a combination thereof. In some embodiments, the TCP proxy 122 is a portion of the respective IMA 124.

The IMA 124 is generally a device providing a pre-selected combination of QoS and resource management functions in the respective network edge device 120. The IMA 124 has a modular architecture and may be a stand-alone (i.e., detachable) or, alternatively, integral portion of a computer, a router, a switch, a routing switch, or a server, among other network-accessible devices.

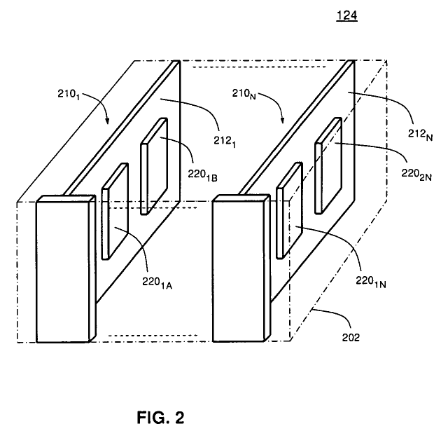

Elements of the IMA 124 (discussed below in reference to FIG. 2) form an upgradeable suite of particular QoS and resource management functions. In operation, modular architecture of the IMA 124 provides flexibility to a network designer in deciding which specific communication capabilities need to be enabled or modified at specific ingress/egress points of the core network 110.

In some embodiments, the IMA 124 may encorporate at least one of the TCP 122 proxy or encryption module 126 of the network edge device 120, as well as the IMA 124 or a combination of the IMA 124 and encryption module 126 may be a portion of the server 112 of the core network 110.

Referring to FIG.2, in on one embodiment, the IMA 124 includes a plurality of N functional units 210 (N≧1), which may structurally be disposed within the same enclosure 202 (shown in phantom) and adapted for plugging into a slot of a respective network edge device 120 (for example, a server). Alternatively, at least some functional units 210 may occupy separate slots in the network edge device 120.

A functional unit 210 is generally a printed circuit board 212 (e.g., server blade) comprising at least one module 220. Each module 220 is an integrated circuit device (for example, system-in-package (SiP) or system-in-module (SiM) device), which is configured to perform one or more pre-selected QoS and resource management functions in the respective network edge device 120.

In a preferred embodiment, the IMA 124 is realized as a combination of hardware and software components (not shown). The software component is embedded in a memory of the respective hardware component and is executable by a processor of that hardware component. Such configuration of the IMA 124 facilitates scalability and modularity of the hardware and software architectures of both the IMA 124 and the network edge device 120, thereby providing a variety of mutually compatible solutions for increasing QoS and performance of resource management in the device 120.

In one embodiment, the IMA 124 includes at least one functional unit 210 that comprises one or more of the discussed below modules 220A-220S, as selected by a designer of the respective network edge device 120.

A Measurement Collection and Analysis (MCCA) module 220A is configured for optimizing operation of the functional units 210 of the IMA 124 and their respective modules based on statistical and real-time analysis of information pertaining to transmission properties of the core network 110. Such information is combined with network management configuration parameters to determine configuration attributes for other modules of the IMA 124 (for example, to adjust dynamically levels of robustness or compression of Voice-over-Internet (VoIP) or data transmissions).

A VoIP booster module 220B is configured for mitigating packet losses in the core network 110 by using VoIP packets each including a payload of at least one preceding VoIP packet. Considering the fact that in VoIP messages the ratio of payloads to headers is relatively small, the module 220B, while slightly increasing a packet size to compensate for packet losses, does not increase the number of VoIP packets entering the core network 110. Such a technique is described in detail in commonly assigned patent application Ser. No. 11/518705, filed on Sep. 11, 2006 (Attorney Docket No. 05-11385-06).

A VoIT Compressor module 220C is configured for selectively reducing a number of VoIP packets entering the core network 110. The packets are concatenated to form integrated datagrams, each such datagram having an encryption protocol-specific overhead block. A number of the data packets in an integrated datagram is dynamically defined based on assessment of a plurality of pre-determined parameters, including a traffic load, a type of a content of the concatenated data packets, probability of a loss of the data packets, and a Differentiated Services Code Point (DSCP) value. Such a technique is specifically efficient in encrypted core networks and described in detail in commonly assigned patent application Ser. No. 11/670682, filed on Feb. 22, 2007 (Attorney Docket No. 05-11385-15).

A VoIP Call Controller module 220D is configured for supporting the Internet Protocol Private Branch Exchange (IP PBX) or hybrid PBX and at least one of the Session Initiation Protocol (SIP), H.323 protocol, and the Media Gateway Control Protocol (MGCP). In operation, the module 220D allows to control (e.g., by using a Graphical User Interface (GUI)) call switching, manage routes, monitor or record calls, and facilitate IP, analog (e.g., Plain Old Telephone Service (POTS)) and digital (T1/E1) connections, among other functions.

A Space Communications Protocol Specifications-Transport Protocol/Transmission Control Protocol (SCPS-TP/TCP) module 220E is configured for enhancing performance of packetized data transmissions over communications satellite (SATCOM) links by providing to the network edge device 120 Performance Enhancement Proxy (PEP) capabilities defined in SCPS-TP standard recommended by the Consultative Committee for Space Data Systems (CCSDS).

A Reed-Solomon (RS) coding module 220F is configured for mitigate packet losses in the core network by transmitting a pre-determined number of redundant data packets. The module 220F uses a coding scheme that allows to recover lost packets using redundant packets, which number is defined by the MCCA module 220A to meet session speed-of-service requirements. In operation, the module 220F increases probability of successful transmission and decreases session completion time and overall number of packets entering, during the session, the core network 110.

A Data Robustness module 220G is configured for replacing a packet flow based on the Transport Protocol (TP) with a packet flow compliant with the Reliable User Datagram Protocol (RUDP). The module 220G accelerates TCP performance (especially in environments producing high packet loss in the core network 110), while reducing the number of packets entering the core network, thus optimizing utilization of resources of the core network 110.

A Multilevel Precedence and Preemption (MLPP) module 220H is configured for controling access to resources of the core network based on levels of precedence of messages. In operation, the module 220H increases flow of high precedence sessions, thus optimizing utilization of resources of the core network 110. Such a technique is based on a Multilevel Precedence and Preemption (MLPP) scheme and described in detail in commonly assigned patent application Ser. No. 11/670623, filed on Feb. 22, 2007 (Attorney Docket No. 05-11385-11).

A Data Compression module 2201 is configured for compressing payloads of data packets in compliance with File Transfer Protocol (FTP) and Transmission Control/Internet Protocols (TCP/IP). In operation, the module 2201 increases bandwidth utilization in the core network 110.

An Information Assurance module 220J is configured for detecting data intrusion or jamming attempts based on statistical analysis of performance of particular transmission links in the core network 110. In operation, settings and parameters of the module 220J are determined using information provided by the MCCA module 220A.

A Resource ReSerVation Protocol (RSVP) module 220K is configured for providing Measurement Based Admission Control (MBAC) function. In operation, in high congestion conditions, the module 220K grants or denies outgoing traffic through the network edge device 120 based on intensity of real-time traffic flow congestions in the core network 110.

A Rate Control module 220L is configured for selective regulating a rate of a packet flow for outgoing traffic through said network edge device based on bandwidth of transmission links coupled to the core network. In operation, the module 220L matches the rates of different classes of service at the network edge device 120 with bandwidths of specific network paths.

A Secure Socket module 220M is configured for supporting at least one cryptographic communication protocol used by the network edge device 120 and the core network 110 (for example, HAIPE or IPSec protocols).

A Video Tele-Conferencing (VTC) module 220N is configured for boosting performance of high precedence VTC sessions to mitigate adverse transmission in the core network 110 by using datagrams selectively including redundant payloads of preceding datagrams.

A Multicast module 2200 is configured for dynamically building destination trees and sending multicast addresses over the enterprise and secure core networks 110.

A RF Signal Blockage Detection module 220P is configured for detecting blockages of RF transmissions caused by temporarily obstructions by objects such as buildings, vehicles, etc. In operation, the module 220P utilizes information provided by the MCCA module 220A.

A Policy Generation module 220Q is configured for defining message admission and pre-emption polices to mitigate traffic congestions in the enterprise and secure core networks 110.

A Flow Separation module 220R is configured for providing separation of multiple classification traffic flows of incoming/outgoing traffic to reduce delays for traffic having different classifications.

A Dynamic Host module 220S is configured for acquiring Internet Protocol (IP) addresses assigned to clients of Local Area or Wide Area subnets interfaced with the network edge device 120. In operation, the module 220N can roam between the subnets and dynamically acquire the respective IP addresses.

Hereafter, aspects of the present invention are illustratively described within the context of IP-based communication networks and, in particular communication networks where at least portion of information (for example, voice, video, or data) is transmitted in an encrypted format. These networks may comprise wireless, wired, or fiber-optic communication links. It has been contemplated and is within the scope of the present invention that the IMA 124 may also be utilized within the context of other types of communication networks adapted for transmitting digitized information.

Although the invention herein has been described with reference to particular illustrative embodiments, it is to be understood that these embodiments are merely illustrative of the principles and applications of the present invention. Therefore numerous modifications may be made to the illustrative embodiments and other arrangements may be devised without departing from the spirit and scope of the present invention, which is defined by the appended claims.

What is claimed is:

1. An apparatus for providing Quality of Service (QoS) and resource management in a network edge device of a core network, said apparatus having a scalable modular hardware/software architecture and adapted for receiving functional units, each functional unit containing at least one module performing one or more pre-selected QoS and resource management functions in said network edge device.

2. The apparatus of claim 1, wherein said apparatus is a portion of a computer, a router, a switch, a routing switch, or a server.

3. The apparatus of claim 1, wherein said apparatus is a stand-alone portion of a computer, a router, a switch, a routing switch, or a server.

4. The apparatus of claim 1, wherein said apparatus is compatible with a High Assurance IP Encryption (HAIPE) protocol or an IP Security (IPSec) protocol.

5. The apparatus of claim 1, wherein a functional unit contains a Measurement Collection and Analysis module configured for optimizing operation of the functional units and modules thereof based on analysis of transmission properties of the core network.

6. The apparatus of claim 1, wherein a functional unit contains a VoIP booster module configured for mitigating packet losses in the core network by using VoIP packets each including a payload of at least one preceding VoIP packet.

7. The apparatus of claim 1, wherein a functional unit contains a VoIT Compressor module configured for selectively reducing a number of VoIP packets entering the core network by using datagrams each having an overhead block and payload integrating a plurality of payloads of the VoIP packets.

8. The apparatus of claim 1, wherein a functional unit contains a VoIP Call Controller module configured for supporting the Internet Protocol Private Branch Exchange (IP PBX) or hybrid PBX and at least one of the Session Initiation Protocol (SIP), H.323 protocol, and the Media Gateway Control Protocol (MGCP).

9. The apparatus of claim 1, wherein a functional unit contains a Space Communications Protocol Specifications-Transport Protocol/Transmission Control Protocol (SCPS-TP/TCP) module configured for enhancing performance of packetized data transmissions over communications satellite (SATCOM) links by providing Performance Enhancement Proxy (PEP) capabilities to the network edge device.

10. The apparatus of claim 1, wherein a functional unit contains a coding module configured for mitigating packet losses in the core network by transmitting a pre-determined number of redundant data packets.

11. The apparatus of claim 1, wherein a functional unit contains a Data Robustness module configured for replacing a packet flow based on the Transport Protocol (TP) with a packet flow compliant with the Reliable User Datagram Protocol (RUDP).

12. The apparatus of claim 1, wherein a functional unit contains a Multilevel Precedence and Preemption (MLPP) module configured for controling access to resources of the core network based on levels of precedence of messages.

13. The apparatus of claim 1, wherein a functional unit contains a Data Compression module configured for compressing payloads of data packets in compliance with the File Transfer Protocol (FTP) and Transmission Control/Internet Protocols (TCP/IP).

14. The apparatus of claim 1, wherein a functional unit contains an Information Assurance module configured for detecting data intrusion or jamming attempts based on statistical analysis of performance of transmission links in the core network.

15. The apparatus of claim 1, wherein a functional unit contains a Resource ReSerVation Protocol (RSVP) module configured for providing admission control for outgoing traffic through said network edge device based on intensity of traffic flow congestions in the core network.

16. The apparatus of claim 1, wherein a functional unit contains a Rate Control module configured for selective regulating a rate of a packet flow for outgoing traffic through said network edge device based on bandwidth of transmission links coupled to the core network.

17. The apparatus of claim 1, wherein a functional unit contains a Secure Socket module configured for supporting at least one cryptographic communication protocol.

18. The apparatus of claim 1, wherein a functional unit contains a Video Tele-Conferencing module configured for boosting performance of high precedence sessions by using datagrams selectively including redundant payloads of preceding datagrams.

19. The apparatus of claim 1, wherein a functional unit contains a Multicast module configured for dynamically building destination trees and sending multicast addresses over the core network.

20. The apparatus of claim 1, wherein a functional unit contains a Signal Blockage Detection module configured for detecting blockages of RF transmissions caused by temporarily obstructions in transmission paths.

21. The apparatus of claim 1, wherein a functional unit contains a Policy Generation module configured for defining message admission and pre-emption polices to mitigate traffic congestions in the core networks.

22. The apparatus of claim 1, wherein a functional unit contains a Flow Separation module configured for providing separation of multiple classification traffic flows of incoming/outgoing traffic.

23. The apparatus of claim 1, wherein a functional unit contains a Dynamic Host module configured for acquiring Internet Protocol (IP) addresses assigned to clients of Local Area and Wide Area subnets in communication with said network edge device.

24. The apparatus of claim 1, wherein said apparatus encorporates at least one of a Transmission Control Protocol (TCP) proxy or an encryption module of said network edge device.

25. The apparatus of claim 1, wherein said apparatus or a combination of said apparatus and an encryption module of said network edge device is a portion of a server of the core network.

26. A network edge device comprising the apparatus of claim 1, said network edge device providing at least one commercial or enterprise subnet with an access to the core network.

27. The apparatus of claim 1, wherein the core network is a wireless, wired, or fiber-optic communication network.
